(19) United States
(12) Patent Application Publication
(10) Pub. No.: US 2012/0182342 A1
(43) Pub. Date: Jul. 19, 2012

(54) HIGH-SPEED PAGE WIDE MULTIPLE-PASS PRINTING METHOD AND A PRINTING DEVICE ADAPTIVE TO THE HIGH-SPEED PAGE WIDE MULTIPLE-PASS PRINTING METHOD

(76) Inventors: Ching Sung Lin, Hsin-Chu (TW); Hung Chuan Lo, Hsin-Chu (TW)

(21) Appl. No.: 13/347,230

(22) Filed: Jan. 10, 2012

(30) Foreign Application Priority Data
Jan. 14, 2011 (CN) 201110024904.4

(51) Int. Cl. B41J 29/38

(52) U.S. Cl. 347/14

(57) ABSTRACT

The present invention relates to a high-speed page wide multiple-pass printing method, comprising the steps of: (a) providing a printing device and a medium, wherein the printing device comprises a control unit, a printing module and a storing module; (b) the control unit receiving and grouping the data into an odd-number group and an even-number group, then storing the grouped data in the storing module and transmitting a printing order; (c) the printing module receiving the printing order, extracting the data grouped into the odd-number group, and executing a first ink-jet printing operation to a printing region of the medium; (d) the printing module extracting the data grouped into the even-number group and executing a second ink-jet printing operation to the printing region; and (e) the printing module completing the second ink-jet printing operation for forming a complete printing image on the medium.

### CROSS REFERENCE TO RELATED APPLICATION

This application claims the benefits of the China Patent Application Serial Number 201110024904.4, filed on Jan. 14, 2011, the subject matter of which is incorporated herein by reference.

### BACKGROUND OF THE INVENTION

1. Field of the Invention

The present invention relates to a printing method and, more particularly, to a high-speed page wide multiple-pass printing method and a printing device adaptive to the high-speed page wide multiple-pass printing method, capable of maintaining the printing quality with an improving printing speed.

2. Description of Related Art

In recent years, with the widely spread of the personal computer among people and the rapid development of the Internet, ink-jet printer has become a popular computer peripheral, and has been widely applied in homes and offices. The main advantage of the ink-jet printer includes its cheap price, low noise-level during the operation, and the better printing quality. Besides, the ink-jet printer can print on almost every kinds of available printing medium, such as an ordinary paper, a special ink-jet printing paper, a photo paper and a slide, etc. In addition, as well known in the related art, a lot of factors may affect the printing quality of an ink-jet printer, such as the composition of the ink, the selection of the paper, and the ink-supply mechanism of the ink cartridge. However, since the ink-jet printing method of the ink-jet printer plays an important role on the resulting printing quality, developers in the related filed have put a lot of effort and time in developing an improving the ink-jet method of the ink-jet printer, in order to meet the demands on the better printing quality and the higher printing speed at the same time.

The main limitation on the ink-jet printing speed of the conventional ink-jet printer is the ink-jet frequency thereof. The ink-jet printing operation of the conventional ink-jet printer is shown in FIG. 1A and FIG. 1B. The ink cartridge 10 of the ink-jet printer 1 moves along with the optical encoder 11 having the pattern consisting of interleavingly arranged black-regions and white-regions, as shown in FIG. 1A. In the case of a 600 dpi image to be printed, when the ink-jet frequency of the ink cartridge 10 is 12 k Hz and the “unit 110” of the optical encoder 11, consisting of one black region and the adjacent white region, corresponds to the distance of 1/600 inch, the moving speed of the ink cartridge 10 during the execution of the printing process can be calculated by the following formula:

(1/600)/(1/12 k)=20 (inch/s)

That is, the printing speed of the ink cartridge 10 is 20 inch/sec, which means the ink cartridge 10 moves 20 inch per second during the execution of the printing process.

Therefore, when the ink cartridge 10 of the conventional ink-jet printer executes the printing operation with the 600 dpi resolution, the maximum printing speed thereof is 20 inch/sec. The conventional way for improving the printing speed in the conventional ink-jet printer is to decrease the printing resolution, such as decreasing the printing resolution from pervious 600 dpi, down to 300 dpi. In this case, two units 110 and 111 of the optical encoder 11, both of them consisting of one black region and the adjacent white region, correspond to the distance of 1/300 inch. Then, the moving speed of the ink cartridge 10 during the execution of the printing process can be calculated by the following formula:

(1/300)/(1/12 k)=40 (inch/s)

That is, when the resolution is decreasing (from 600 dpi down to 300 dpi), the printing speed of the ink cartridge 10 is 40 inch/sec, which is two times of the above-mentioned printing speed (20 inch/sec). However, even though the printing speed is effective increased, the printing quality of the printed image is inevitably deteriorated due to the decrease of the printing resolution, which is not favorable for the end-user of the printed image.

In addition to the above-mentioned conventional printing method, some of the currently in-use printing output device adopts the high-speed page wide printing technology, for executing the high-speed printing operation to print out documents and images having a higher printing quality. The high-speed page wide printing technology has been widely applied in the printing devices in the industry and at homes, for example, the ink-jet printers, the laser printers and the dot-matrix printers. Besides, the high-speed page wide printing technology can further be divided into the single-pass printing technology and the multiple-pass printing technology. The printer adopting the single-pass printing technology executes the printing operation by means of partitioning the image data into a plurality of printing regions. Then, in every of the plurality of printing regions, only one printing process is executed by the printer. That is, at the image position of every of the plurality of printing regions, the image is formed with the single injection of the ink, through the plural ink-jet nozzles of the ink cartridge. Thus, the single-pass printing technology has the advantage of ink saving. However, when any of the plural ink-jet nozzles of the ink cartridge is blocked or made of bad-quality material, for example, when the size of the ink injected through the ink-jet nozzle is too small, when only portions of the drop of the ink is injected through the ink jet nozzle, when the ink is injected in wrong direction, or when the distribution of the ink injected is not even, one or more thin white line is formed at the image position, resulting in the non-completed image formation or in the bad printing quality, after the execution of the single-pass printing operation. As a result, unnecessary waste of the paper and the ink is produced, resulting in the raising of the printing cost, the increasing of the time cost of the industry and the consumption on the natural source.

For solving the aforementioned thin white line issue happened in the single-pass printing operation, which causes the deterioration of the printing quality, multiple-pass printing operation is proposed and executed. The conventional multiple-pass printing operation is shown in FIG. 2A. The printing device (not shown in the figure), adaptive to the multiple-pass printing operation, has an ink cartridge (not shown in the figure). The ink cartridge has a plurality of ink-jet nozzles (not shown in the figure). When the printing device executes the printing operation to the medium 20, for example (but not limited to) a piece of paper, the printing device executes the printing operation to the first printing region 21 of the medium, wherein the side length L of the first printing region 21 is substantially equal to the side length of the ink cartridge of the printing device. Thus, a first image block 21′ is printed on the medium 20. Then, with the operation of the feeding mechanism (not shown in the figure) of the printing device, the medium 20 is fed (moved) a distance of ½ L, in the direction indicated by the arrow B in FIG. 2A. After the execution of the feeding process, a second printing region 22 is formed. The printing device then executes the printing operation to the second printing region 22. Thus, a second image block 22′ is printed on the medium 20. At this time, the upper portion 221′ of the second image block 22′ is overlapped with the lower portion 211′ of the first image block 21′. Similarly, after the medium 20 is fed a distance of ½ L once again, a third printing region 23 is formed. The printing device then executes the printing operation to the third printing region 23. Thus, a third image block 23′ is printed on the medium 20. At this time, the upper portion 231′ of the third image block 23′ is overlapped with the lower portion 222′ of the second image block 22′. After the execution of the multiple-pass printing operation, a complete image A′ is formed in the region A.

Please refer to FIG. 2B, which is a schematic diagram displaying the image stitching process of the conventional multiple-pass printing method. As shown in the figure, when the printing device, adaptive to the conventional multiple-pass printing method, is going to print the complete image A′ on the medium through the image stitching process, at least the first image block 21′, the second image block 22′ and the third image block 23′ are required to be printed on the medium. Wherein, the lower portion 211′ of the first image block 21′ is overlapped with the upper portion 221′ of the second image block 22′, for forming the upper portion A1 of the complete image A′. In addition, the lower portion 222′ of the second image block 22′ is overlapped with the upper portion 231′ of the third image block 23′, for forming the lower portion A2 of the complete image A′.

The processing unit of the printing device (not shown in the figure) adaptive to the multiple-pass printing technology, computes the image content of every of the image blocks 21′, 22′, 23′, basing on the interaction of two special masks M1, M2 and the complete image A′. As shown in FIG. 2C, since the upper portion A1 of the complete image A′ is formed by overlapping the lower portion 211′ of the first image block 21′ with the upper portion 221′ of the second image block 22′, the upper portion A1 of the complete image A′ is aligned with the lower portion 211′ of the first image block 21′ first, then the upper portion A1 of the complete image A′ is interacted with the special mask M1, in order to compute the printing information of the first image block 21′. Then, the upper portion A1 of the complete image A′ and the lower portion A2 of the complete image A′ are interacted with the special mask M2, in order to compute the printing information of the second image block 22′, wherein the special mask M2 is substantially the opposite mask of the special mask M1. However, the orientation of the special mask M1 and the special mask M2 are not thus limited. At final, the lower portion A2 of the complete image A′ is aligned with the upper portion 231′ of the third image block 23′, then the lower portion A2 of the complete image A′ is interacted with the special mask M1 for computing the printing information of the third image block 23′. After executing the above-mentioned processes, the printing information of these three image blocks, i.e. the first image block 21′, the second image block 22′ and the third image block 23′ are all obtained and written into the storing module 25, as shown in FIG. 2D. Then, the ink cartridge of the printing device prints the printing information of these three image blocks in the first printing region 21, the second printing region 22 and the third printing region 23, both correspondingly and respectively, in order to form the complete image A′ in the region A.

When the printing device executes the multiple-pass printing operation, the ink-jet printing operation executed to every of the printing regions 21, 22, 23 are similar to the ink-jet printing operation of the conventional printing method. The ink cartridge of the printing device moves along with the optical encoder 24 having the pattern consisting of interleavingly arranged black-regions and white-regions. When the image data of 600 dpi is going to be printed, the unit 240 of the optical encoder 24, consisting of one black region and the adjacent white region, corresponds to the distance of 1/600 inch. Taking the first image block 21′ shown in FIG. 2D as an example, when the ink cartridge executes the printing operation, the printing information previously calculated and obtained is “called” from the storing module 25 and arranged at their corresponding locations in sequence, enabling every of these printing information correspond to two units 240, 241 of the optical encoder 24. The ink cartridge then moves along with the optical encoder 24, for ink-jet printing the image information of the first image block 21′. However, even though a complete image A′ having a better printing quality can be obtained through the multiple-pass printing method, the printing speed of the multiple-pass printing method is the same as the conventional printing method, which is only 20 inch/sec and difficult to be further increased.

Therefore, it is desirable to provide an improved high-speed page wide multiple-pass printing method, and a printing device adaptive to the improved high-speed page wide multiple-pass printing method, for mitigating and/or obviating the afore-mentioned problems, maintaining the printing quality of the printing operation, and increasing the printing speed significantly, with the lowered cost and the minimized unnecessary waste.

### SUMMARY OF THE INVENTION

The main object of the present invention is to provide a high-speed page wide multiple-pass printing method and a printing device adaptive to the high-speed page wide multiple-pass printing method, capable of solving the drawback of the conventional printing method, such as the limited printing speed and the decrease of the printing quality happening with the increase printing speed thereof.

To achieve the object, a broader aspect of the present invention is to provide a high-speed page wide multiple-pass printing method, at least comprising the steps of: (a) providing a printing device and a medium, wherein the printing device at least comprises a control unit, a printing module and a storing module; (b) the control unit receiving a data and grouping the data into an odd-number group and an even-number group, wherein the data grouped into the odd-number group and the data grouped into the even-number group is stored in the storing module, the control unit then transmitting a printing order; (c) the printing module receiving the printing order and extracting the data grouped into the odd-number group from the storing module, the printing module then executing a first ink jet printing operation to a printing region of the medium; (d) when the first ink-jet printing operation being completed, the printing module extracting the data grouped into the even-number group from the storing module, and the printing module then executing a second ink-jet printing operation to the printing region of the medium; and (e) the printing module completing the second ink-jet printing operation, for forming a complete printing image on the medium.

To achieve the object, another broader aspect of the present invention is to provide a printing device, for executing a high-speed page wide multiple-pass printing operation to a medium, at least comprising: a control unit, for receiving a data and grouping the data into an odd-number group and an even-number group; a printing module; and a storing module; wherein the control unit stores the data grouped into the odd-number group and the data grouped into the even-number group in the storing module and transmits a printing order to the printing module, for enabling the printing module to extract the data grouped into the odd-number group from the storing module and execute a first ink-jet printing operation to a printing region of the medium; then, the printing module extracting the data grouped into the even-number group from the storing module and executing a second ink-jet printing operation to the printing region of the medium, for forming a complete printing image on the medium.

### BRIEF DESCRIPTION OF THE DRAWINGS

FIG. 1A is a schematic diagram displaying the ink-jet printing operation of the conventional ink-jet printer with the resolution of 600 dpi.

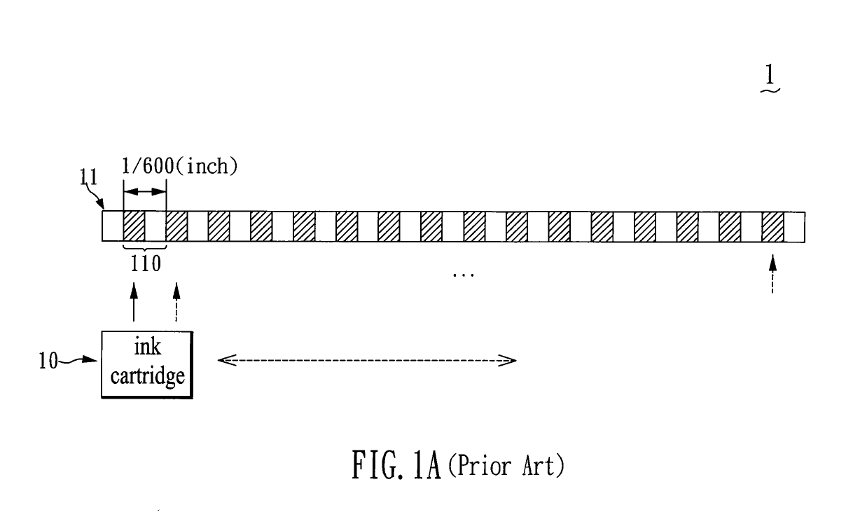

FIG. 1B is a schematic diagram displaying the ink-jet printing operation of the conventional ink-jet printer with the resolution of 300 dpi.

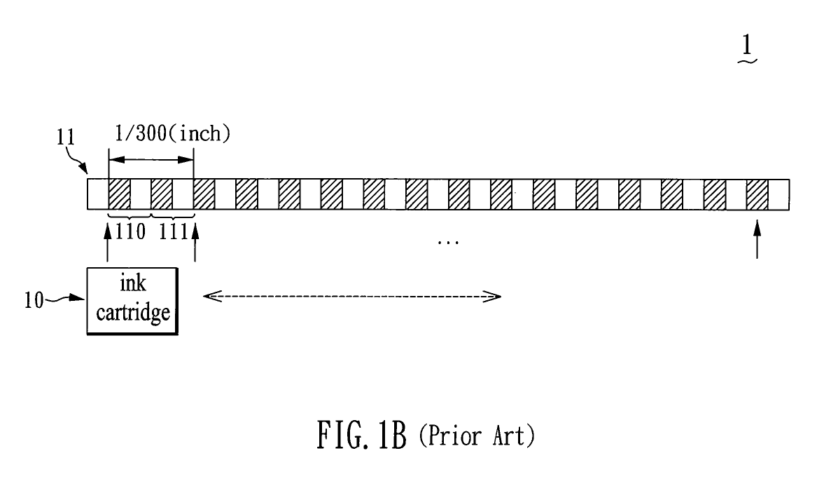

FIG. 2A is a schematic diagram displaying the image formation of the conventional multiple-pass printing method.

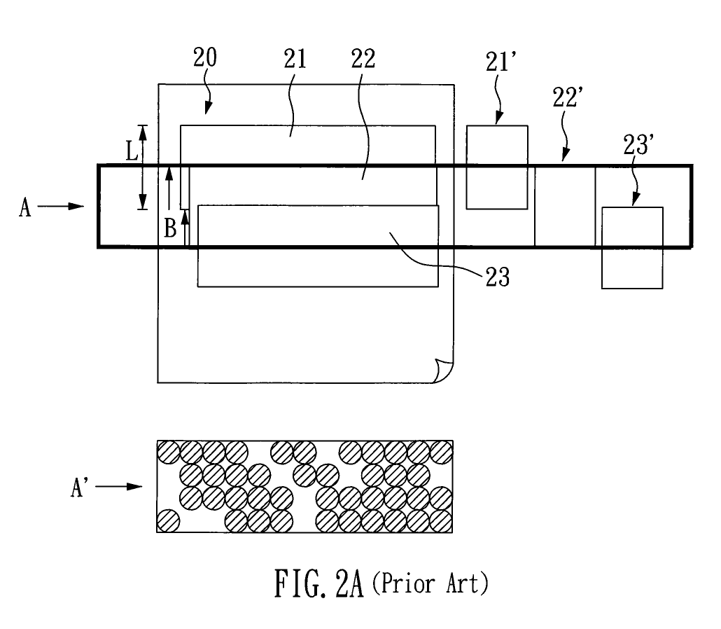

FIG. 2B is a schematic diagram displaying the image stitching process of the conventional multiple-pass printing method.

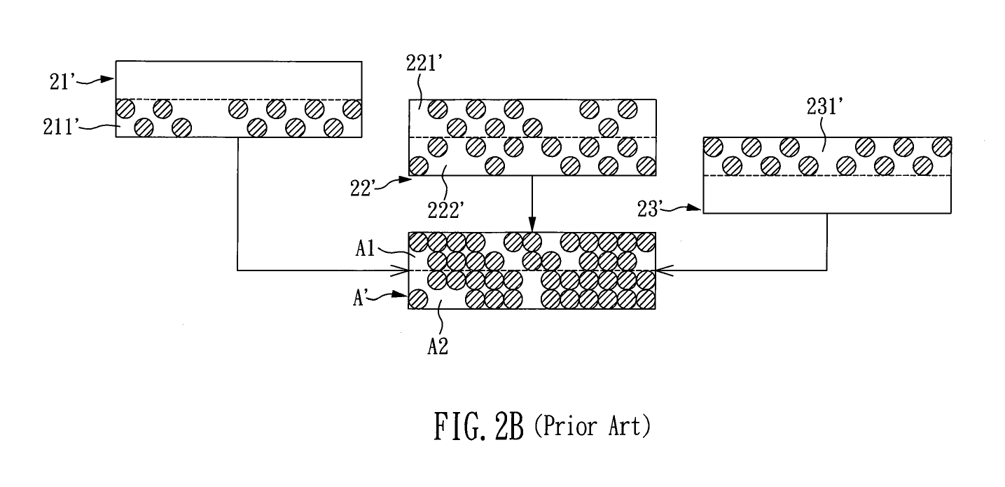

FIG. 2C is a schematic diagram displaying the formation of the image block through the special mask of the conventional multiple-pass printing method.

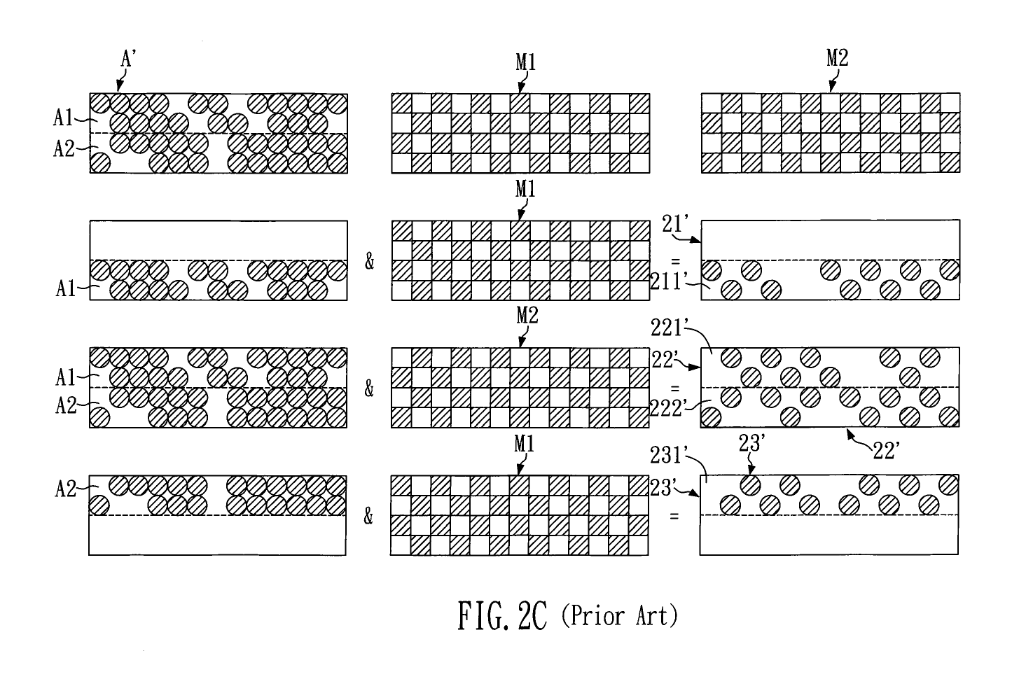

FIG. 2D is a schematic diagram displaying the printing operation of the image block of the conventional multiple-pass printing method.

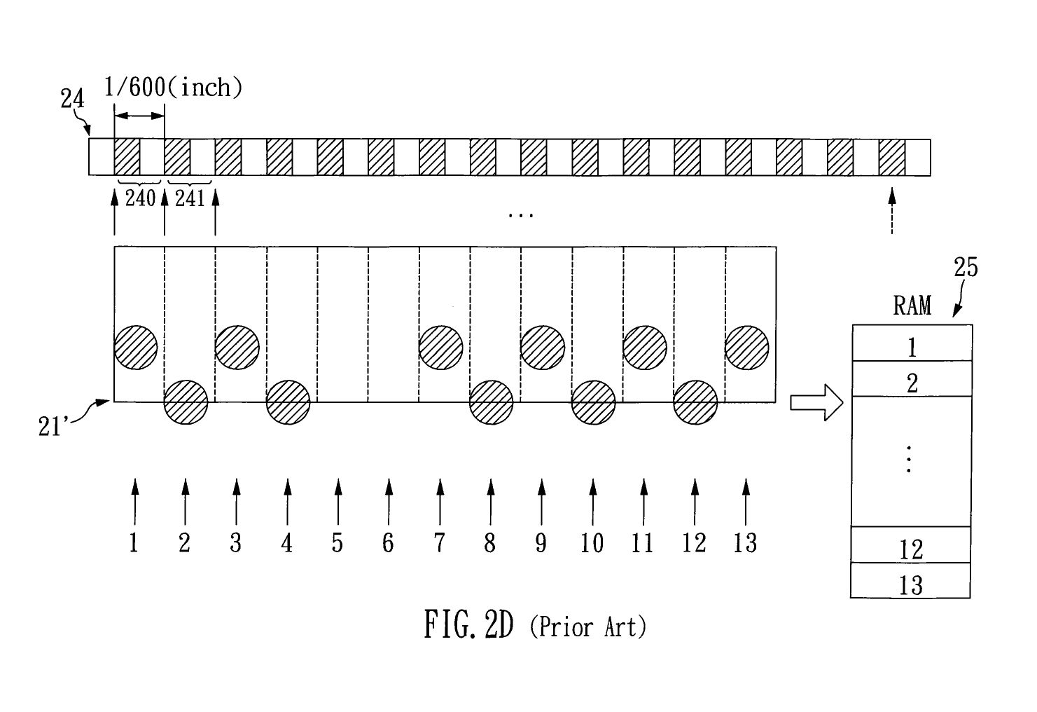

FIG. 3 is a schematic diagram displaying the printing device adaptive to the high-speed page wide multiple-pass printing method, according to one preferred embodiment of the present invention.

FIG. 4 is a schematic diagram displaying the flowchart of the high-speed page wide multiple-pass printing method, according to one preferred embodiment of the present invention.

FIG. 5 is a schematic diagram displaying the grouping of the data of the printing device, according to one preferred embodiment of the present invention.

FIG. 6A is a schematic diagram displaying the execution of the first ink-jet printing operation of the high-speed page wide multiple-pass printing method, according to one preferred embodiment of the present invention.

FIG. 6B is a schematic diagram displaying the execution of the second ink-jet printing operation of the high-speed page wide multiple-pass printing method, according to one preferred embodiment of the present invention.

FIG. 6C is a schematic diagram displaying the image formed on the medium through the execution the high-speed page wide multiple-pass printing method, according to one preferred embodiment of the present invention.

### DETAILED DESCRIPTION OF THE PREFERRED EMBODIMENT

Other objects, advantages, and novel features of the invention will become more apparent from the following detailed description when taken in conjunction with the accompanying drawings. The description and the drawing in the specification of the present invention are essentially used for explanation only; they are not supposed to be used for limiting the scope of the present invention.

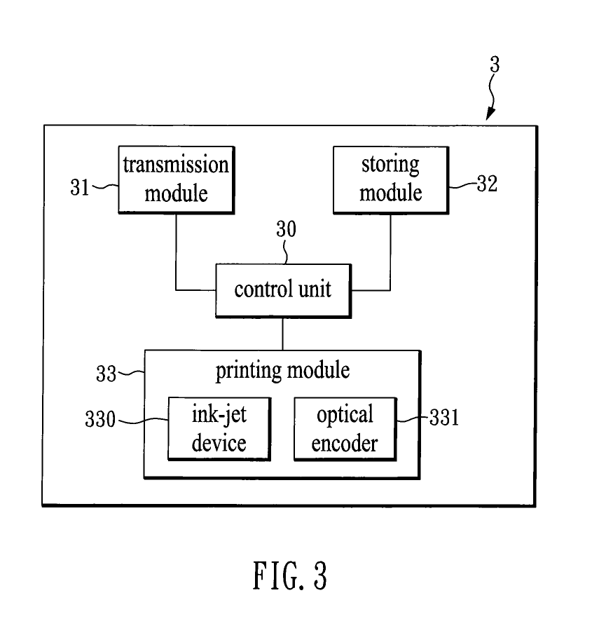

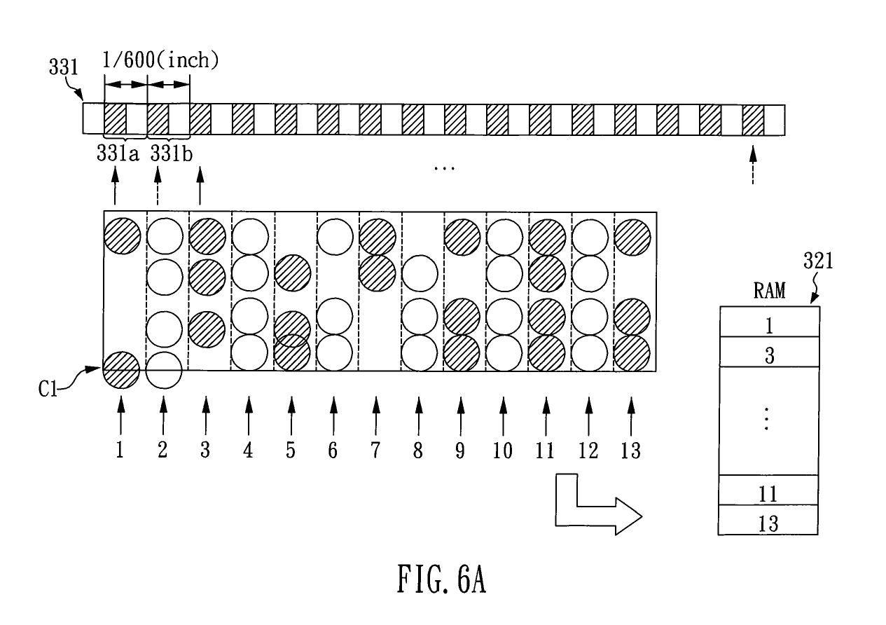

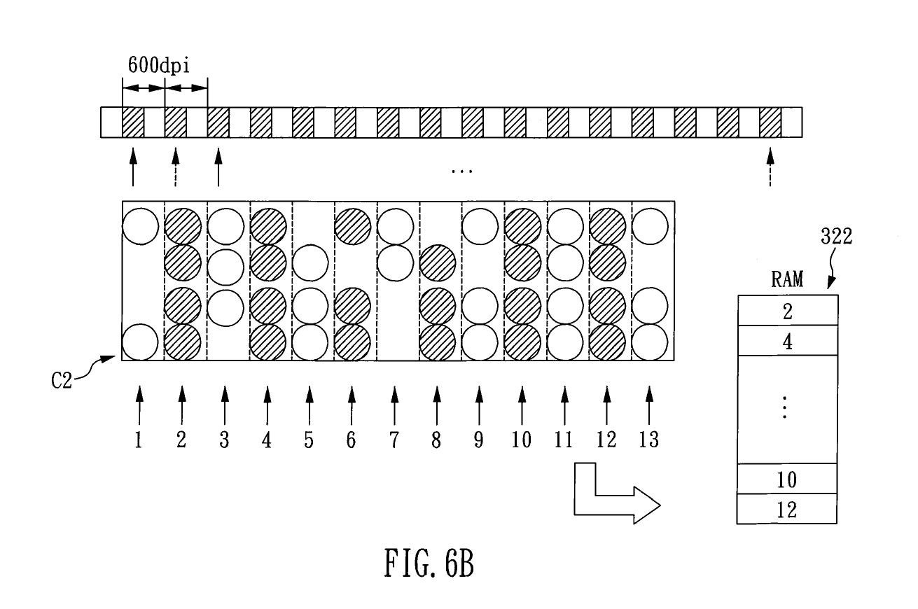

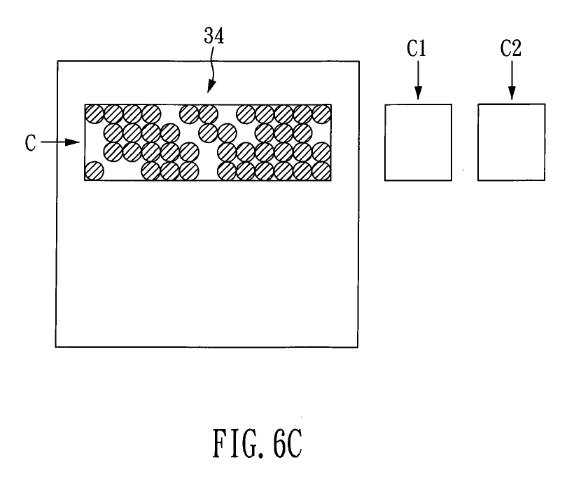

Please refer to FIG. 3, which is a schematic diagram displaying the printing device adaptive to the high-speed page wide multiple-pass printing method, according to one preferred embodiment of the present invention. As shown in the figure, the printing device 3 mainly comprises: a control unit 30, a transmission module 31, a storing module 32 and a printing module 33, wherein the printing device 3 is adaptive to a high-speed page wide multiple-pass printing method, for executing a printing operation to a medium 34 (as shown in FIG. 6C). The printing device 3 can be, but not limited to, an ink-jet printer, a photo ink-jet printer, or a multifunction printer. The medium 34 can be, but not limited to, an ordinary printing paper, a photo printing paper, an airlaid paper, a letter paper or an envelope.

Wherein, the transmission module 31 is mainly used to be connected with an electronic device (not shown in the figure), for example but not limited not, a personal computer (PC), a notebook PC, a portable PC, a tablet PC, a personal digital assistant, or a smart phone, and to receive the data transmitted from the electronic device. The control unit 30 is mainly used to control the operation of the transmission module 31, the storing module 32 and the printing module 33. Besides, the control unit 30 receives the data from the transmission module 31 for progressing and transforming, storing the transformed data in the storing module 32 and transmitting a printing signal. The printing module 33 is used to receive the printing signal from the control unit 30, to extract the data having been processed and transformed from the storing module 32, and to execute a printing operation basing on the printing signal, for printing the transformed data on the medium 34.

In some embodiments of the present invention, the control unit 30 can be, but not limited to, a central processing unit (CPU), for coordinating the operation of every units of the printing device 3 and integrating the printing operation. The storing module 32 can include, but not limited to, a flash memory and a Synchronous Dynamic Random Access Memory (SDRAM), as the storing space for the cache and buffer of the program, the file or the transformed image data. The printing module 33 at least comprises an ink-jet device 330 and an optical encoder 331. The ink-jet device 330 can be, but not limited to, an ink cartridge and have a plurality of ink-jet nozzles (not shown in the figure). The optical encoder 331 has the pattern consisting of interleavingly arranged black-regions and white-regions, wherein one black region and the adjacent white region are called as a “unit”.

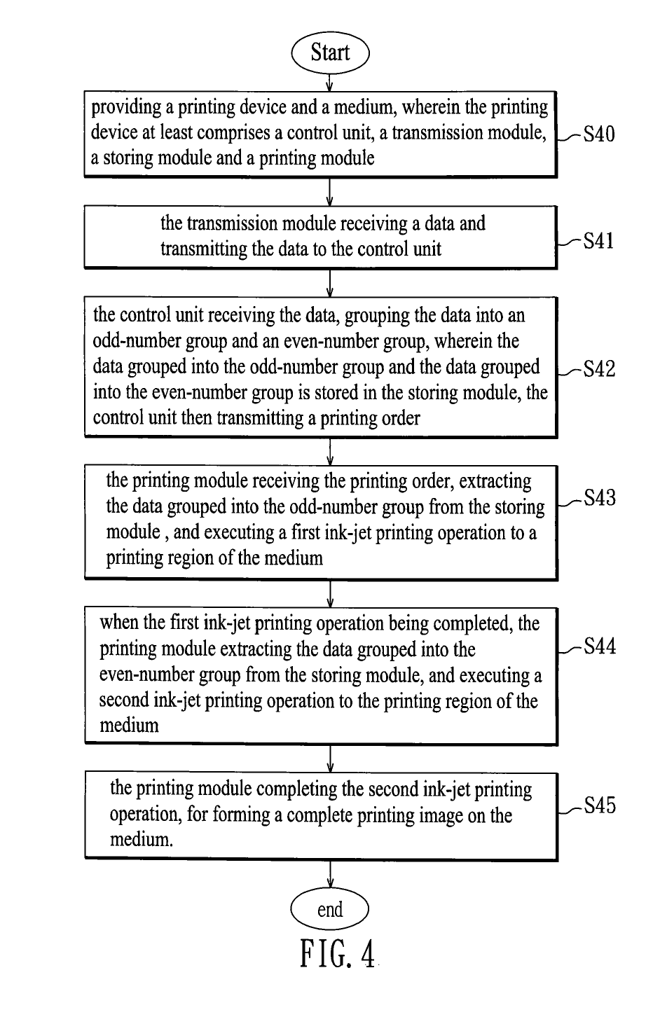

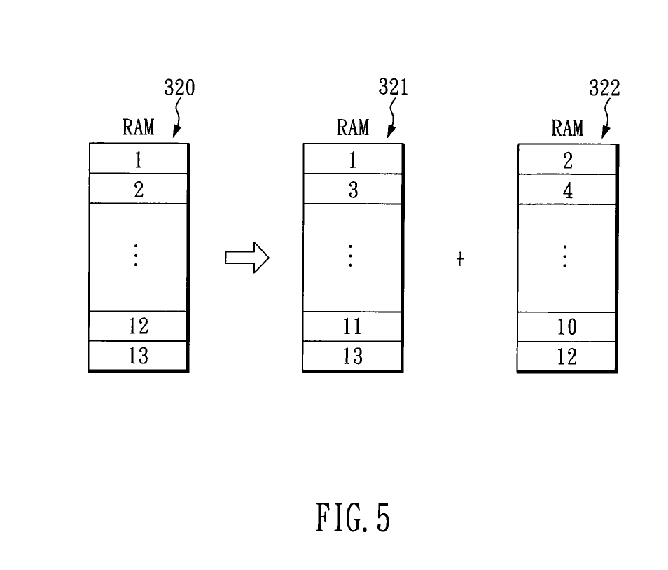

Please refer to FIG. 4, which is a schematic diagram displaying the flowchart of the high-speed page wide multiple-pass printing method, according to one preferred embodiment of the present invention. As shown in the figure, the high-speed page wide multiple-pass printing method at least comprises the following steps: First, as described in the step S40, providing a printing device 3 adaptive to the high-speed page wide multiple-pass printing method and a medium 34, wherein the printing device 3 at least comprises a control unit 30, a transmission module 31, a storing module 32 and a printing module 33. Then, as described in the step S41, the transmission module 31 receives a data 320 (as shown in FIG. 5), and transmits the data 320 to the control unit 30. As described in the step S42, after the control unit 30 receiving the data 320, the control unit 30 analyzes and processes the data 320, for grouping the data 320 into an odd-number group and an even-number group, wherein the data grouped into the odd-number group 321 (as shown in FIG. 5) and the data grouped into the even-number group 322 (as shown in FIG. 5) is stored in the storing module 32. Then, the control unit 30 transmits a printing order. A described in the step S43, when the printing module 33 receives the printing order, the printing module 33 extracts the data grouped into the odd-number group 321 from the storing module 32, and executes a first ink-jet printing operation C1 (as shown in FIG. 6C) to a printing region C of the medium 34 (as shown in FIG. 6C). As described in the step S44, when the first ink-jet printing operation C1 being completed, the printing module 33 extracts the data grouped into the even-number group 322 from the storing module 32, and the printing module 33 then executes a second ink-jet printing operation C2 (as shown in FIG. 6C) to the printing region C of the medium 34. At final, as described in the step S45, the printing module 33 completes the second ink-jet printing operation C2, for forming a complete printing image on the medium 34. In this manner, the printing device 3 can execute the printing operation to the medium 34, by grouping the data into an odd-number group and an even-number group and through the execution of the high-speed page wide multiple-pass printing method.

Please refer to FIG. 5, which is a schematic diagram displaying the grouping of the data of the printing device, according to one preferred embodiment of the present invention. For example, when the transmission module 31 of the printing device receives the data 320, the transmission module 31 arranges the data 320 in sequence and stores the data 320 in the random access memory (RAM). In this manner, when the printing module 33 executes the printing operation, the ink-jet device 330 executes the ink-jet printing operation of every data of one point, basing on the corresponding locations in the random access memory (RAM) where storing the data 320 stores. However, this kind of the execution of the ink-jet printing operation limits the printing speed thereof. Therefore, in the present embodiment, after the transmission module 31 receiving the data 320, the data 320 will be transmitted to the control unit 30 for analyzing and processing. At this time, the control unit 30 groups the data 320 into the data grouped into the odd-number group 321 and the data grouped into the even-number group 322, wherein the data grouped into the odd-number group 321 and the data grouped into the even-number group 322 are stored in the random access memory (RAM) in sequence.

Please refer to FIG. 6A, which is a schematic diagram displaying the execution of the first ink-jet printing operation of the high-speed page wide multiple-pass printing method, according to one preferred embodiment of the present invention. As shown in the figure, when the printing module 33 receives the printing order, the printing module 33 first extracts the data grouped into the odd-number group 321 and arranges the data grouped into the odd-number group 321 in sequence, wherein every of the data grouped into the odd-number group 321 corresponds to the graduation of the optical encoder 331. That is, in the present embodiment, every of the data grouped into the odd-number group 321 corresponds to “one unit” of the optical encoder 331, which is consisted of one black region and the adjacent white region. For example, the data arranged at a first location of the first ink jet printing operation C1 corresponds to the unit 331a of the optical encoder 331, wherein the data arranged at a second location of the first ink-jet printing operation C1 corresponds to the next unit 331b of the optical encoder 331, and so on. However, since in the first ink-jet printing operation C1, the data being extracted from the storing module 32 is the data grouped into the odd-number group 321, the data at the even-number location is the null information. Therefore, during the execution of the first ink-jet printing operation C1, the data at the first location and the data at the second location can be processed as a “set” of information. Moreover, since the optical encoder 331 in every 1/600 inch is called as “one unit”, the ink-jet device 330 moves along with the optical encoder 331 during the execution of the first ink-jet printing operation C1, in the step-distance equal to two units (including unit 331a and unit 331b and corresponding to the distance of 1/600 inch+ 1/600 inch= 1/300 inch) of the optical encoder 331, for ink-jet printing the first set of information (including the data at the first location and the data at the second location). Thus, the execution of the first ink-jet printing operation C1 is the execution of the snapshot of the data grouped into the odd-number group 321. In addition, as the moving distance of the ink-jet device 330 along with the optical encoder 331 is two times ( 1/300 inch) to the moving distance ( 1/600 inch) of ink jet device 330 previously for printing a data of one point, the printing speed during the execution of the first ink-jet printing operation C1 is increased to two times of the conventional printing method, through the snapshot technology described above.

Please refer to FIG. 6B, which is a schematic diagram displaying the execution of the second ink-jet printing operation of the high-speed page wide multiple-pass printing method, according to one preferred embodiment of the present invention. As shown in the figure, when the first ink jet printing operation being completed, the ink jet device 330 of the printing module returns to its original position. Then, the printing module 33 extracts the data grouped into the even-number group 322 from the storing module 32, and arranges the data grouped into the even-number group 322 in sequence, wherein every of the data grouped into the even-number group 322 corresponds to the graduation of the optical encoder 331, for executing the second ink-jet printing operation C2 to the printing region C of the medium 34. That is, the execution of the second ink-jet printing operation C2 is the execution of the snapshot of the data grouped into the odd-number group 321 to the printing region C of the medium 34. However, since the arranging method of the data and the ink-jet printing method of the second ink-jet printing operation C2 is similar to those of the first ink-jet printing operation C1, detailed description regarding the arranging method of the data and the ink-jet printing method of the second ink-jet printing operation C2 are omitted hereinafter. It should be noticed that, during the execution of the second ink-jet printing operation C2, the data to be ink-jet printed is at the even-number locations, i.e. a second location, a fourth location, and etc. Similarly, the data at the odd-number location, for example, the first location and the third location, is the null information. Therefore, during the execution of the second ink-jet printing operation C2, the data at the first location and the data at the second location can be processed as a “set” of information, enabling the moving distance of the ink-jet device 330 along with the optical encoder 331 to be two times ( 1/300 inch) to the moving distance ( 1/600 inch) of the ink jet device 330 previously for printing a data of one point. That is, the execution of the snapshot of the second ink-jet printing operation C2 is the same as that of the snapshot of the first ink-jet printing operation C1, enabling the printing speed during the execution of the second ink-jet printing operation C2 is also increased to two times of the conventional printing method.

As described above, after the rearrangement and sequencing of the data, the ink-jet device 330 moves along with the optical encoder 331 in the step-distance equal to two units and ink-jets a data during the execution of both the first ink-jet printing operation C1 and the second ink-jet printing operation C2, enabling the ink-jet device 330 to achieve the printing speed in the case of 300 dpi in its every passes over the medium, which is two times to the printing speed in the case of 600 dpi. As shown in FIG. 6C, by overlapping the image printed on the medium 34 after the execution of the second ink-jet printing operation C2, with the image previously printed in the printing region C of the medium 34 after the execution of the first ink-jet printing operation C1, the high-speed page wide multiple-pass printing method of the present invention can maintain the resolution of the image printed on the medium 34 at the 600 dpi, without the deterioration of the printing quality usually happening along with the increase of the printing speed.

In conclusion, the high-speed page wide multiple-pass printing method of the present invention and the printing device adaptive thereto can achieve the object of increasing the printing speed to two times for printing the same data, maintaining the printing quality, decreasing the manufacturing cost, and minimizing the unwanted waste with the process including the steps of: grouping the data into an odd-number group and an even-number group, snapshotting the data grouped into the odd-number group to the printing region of the medium through the execution of the first ink-jet printing operation; and snapshotting the data grouped into the even-number group to the same printing region of the medium through the execution of the second ink-jet printing operation.

Although the present invention has been explained in relation to its preferred embodiment, it is to be understood that many other possible modifications and variations can be made without departing from the spirit and scope of the invention as hereinafter claimed.

What is claimed is:

1. A high-speed page wide multiple-pass printing method, at least comprising the steps of:
(a) providing a printing device and a medium, wherein the printing device at least comprises a control unit, a printing module and a storing module;
(b) the control unit receiving a data and grouping the data into an odd-number group and an even-number group, wherein the data grouped into the odd-number group and the data grouped into the even-number group is stored in the storing module, the control unit then transmitting a printing order;
(c) the printing module receiving the printing order and extracting the data grouped into the odd-number group from the storing module, the printing module then executing a first ink-jet printing operation to a printing region of the medium;
(d) when the first ink jet printing operation being completed, the printing module extracting the data grouped into the even-number group from the storing module, and the printing module then executing a second ink jet printing operation to the printing region of the medium; and
(e) the printing module completing the second ink jet printing operation, for forming a complete printing image on the medium.

2. The high-speed page wide multiple-pass printing method as claimed in claim 1, wherein the printing device further comprises a transmission module and the method further comprises a step (b1) before the step (b): the transmission module receiving the data and transmitting the data to the control unit.

3. The high-speed page wide multiple-pass printing method as claimed in claim 1, wherein the printing module further comprises an ink-jet device and an optical encoder having a plurality of units.

4. The high-speed page wide multiple-pass printing method as claimed in claim 3, wherein in the step (d) and the step (e), the ink-jet device moves along with the optical encoder, for executing the first ink jet printing operation of the data grouped into the odd-number group and the second ink-jet printing operation of the data grouped into the even-number group.

5. The high-speed page wide multiple-pass printing method as claimed in claim 4, wherein the ink-jet device moves along with the optical encoder in the step-distance equal to two units of the optical encoder, for executing the first ink-jet printing operation and the second ink-jet printing operation of the data of one point.

6. A printing device, for executing a high-speed page wide multiple-pass printing operation to a medium, at least comprising:
a control unit, for receiving a data and grouping the data into an odd-number group and an even-number group;
a printing module; and
a storing module;
wherein the control unit stores the data grouped into the odd-number group and the data grouped into the even-number group in the storing module and transmits a printing order to the printing module, for enabling the printing module to extract the data grouped into the odd-number group from the storing module and execute a first ink-jet printing operation to a printing region of the medium; then, the printing module extracting the data grouped into the even-number group from the storing module and executing a second ink-jet printing operation to the printing region of the medium, for forming a complete printing image on the medium.

7. The printing device as claimed in claim 6, wherein the printing device further comprises a transmission module for receiving the data and transmitting the data to the control unit.

8. The printing device as claimed in claim 6, wherein the printing module further comprises an ink-jet device and an optical encoder having a plurality of units.
